(19) United States
(12) Patent Application Publication
(10) Pub. No.: US 2010/0057472 A1
(43) Pub. Date: Mar. 4, 2010

(54) METHOD AND SYSTEM FOR FREQUENCY COMPENSATION IN AN AUDIO CODEC

(76) Inventors: Hanks Zeng, Red Bank, NJ (US); Nelson Sollenberger, Farmingdale, NJ (US); Radhakrishnan Kuzhipatt, Irvine, CA (US); Michael Liu, Sunnyvale, CA (US); Taiyi Cheng, San Jose, CA (US); Hongwei Kong, Denville, NJ (US)

Correspondence Address: MCANDREWS HELD & MALLOY, LTD, 500 WEST MADISON STREET, SUITE 3400, CHICAGO, IL, 60661, US

(21) Appl. No.: 12/248,506

(22) Filed: Oct. 9, 2008

Related U.S. Application Data
(60) Provisional application No. 61/091,877, filed on Aug. 26, 2008.

(51) Int. Cl. G10L 21/00

(52) U.S. Cl. 704/500; 704/E19.001

(57) ABSTRACT

In a method and system for frequency compensation in an audio CODEC, a filter in a hardware audio CODEC may be configured based on power consumption and based on a frequency response of an active output device to which the filter is communicatively coupled. The filter may comprise a plurality of filter stages, which may be, for example, biquads, and the filter may be configured by enabling or disabling one or more of the stages. In this manner, power consumption of the filter may be managed by enabling and/or disabling one or more stages. Configuration of the filter may be performed dynamically depending on whether one or more audio output devices may be active. In this regard, which output device is active and its frequency response may be determined and filter coefficients may be reconfigured upon a change in which output device may be active.

### CROSS-REFERENCE TO RELATED APPLICATIONS/INCORPORATION BY REFERENCE

This application makes reference to, claims priority to and claims benefit from U.S. Provisional Patent Application Ser. No. 61/091,877 filed on Aug. 26, 2008.

This application also makes reference to U.S. Provisional Patent Application Ser. No. 61/091,840 filed on Aug. 26, 2008.

Each of the above stated applications is hereby incorporated herein by reference in its entirety.

### FIELD OF THE INVENTION

Certain embodiments of the invention relate to processing of audio signals. More specifically, certain embodiments of the invention relate to a method and system for frequency compensation in an audio CODEC.

### BACKGROUND OF THE INVENTION

In audio applications, systems that provide audio interface and processing capabilities may be required to support duplex operations, which may comprise the ability to collect audio information through a sensor, microphone, or other type of input device while at the same time being able to drive a speaker, earpiece of other type of output device with processed audio signal. In order to carry out these operations, these systems may comprise audio processing devices that provide appropriate gain, filtering, analog-to-digital conversion, and/or other processing of audio signals in an uplink direction and/or a downlink direction. In the downlink direction, an audio processing device may condition and/or process baseband audio signals from a receiver for presentation via audio output devices such as a loudspeaker and headphones. In an uplink direction, an audio processing device may process and/or condition audio signals received from an input device such as a microphone and convey the processed signals to a transmitter.

Limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for frequency compensation in an audio CODEC, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in accordance with an embodiment of the invention.

FIG. 2A is a block diagram illustrating an exemplary audio processing device, in accordance with an embodiment of the invention.

FIG. 2B is a block diagram illustrating exemplary digital processing and analog processing portions of an audio processing device, in accordance with an embodiment of the invention.

FIG. 3 is a block diagram illustrating processing audio signals via a hardware audio CODEC for conveyance to an audio output device and/or an uplink path, in accordance with an embodiment of the invention.

FIG. 4 is a block diagram illustrating an exemplary configurable frequency compensation filter in a hardware audio CODEC, in accordance with an embodiment of the invention.

FIG. 5 is a flowchart illustrating exemplary steps for frequency compensation in a hardware audio CODEC, in accordance with an embodiment of the invention.

### DETAILED DESCRIPTION OF THE INVENTION

Certain aspects of the invention may be found in a method and system for audio level detection and control. In this regard, a filter in a hardware audio CODEC may be configured based on power consumption and based on a frequency response of an active output device to which the filter is communicatively coupled. The filter may comprise a plurality of filter stages, which may be, for example, biquads, and the filter may be configured by enabling or disabling one or more of the stages. In this manner, power consumption of the filter may be managed by enabling and/or disabling one or more stages. Configuration of the filter may be performed dynamically depending on whether one or more audio output devices may be active. In this regard, which output device is active and its frequency response may be determined and filter coefficients may be reconfigured upon a change in the output device that is active.

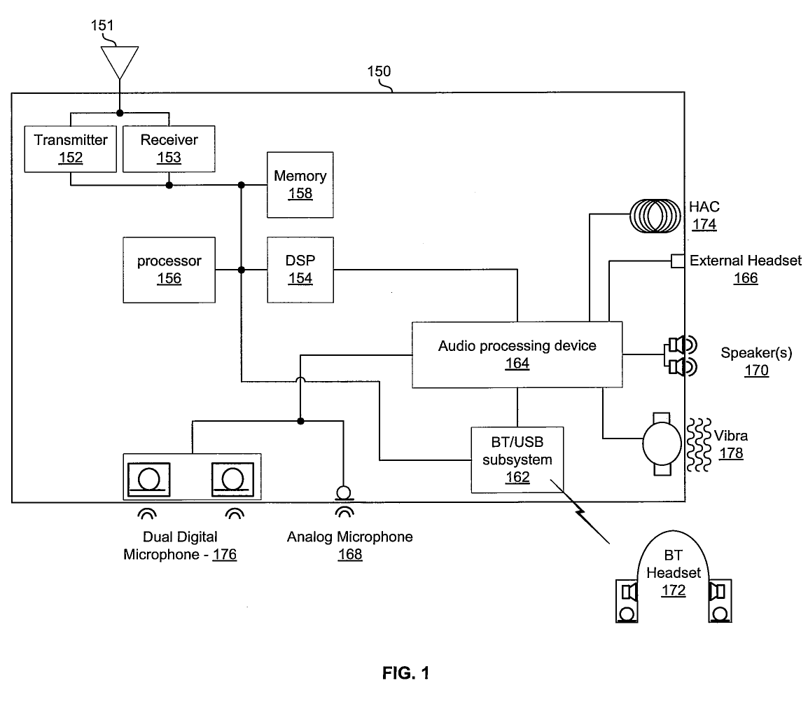

FIG. 1 is a block diagram of an exemplary wireless system, which may be utilized in accordance with an embodiment of the invention. Referring to FIG. 1, the wireless system 150 may comprise an antenna 151, a transmitter 152, a receiver 153, a digital signal processor 154, a processor 156, a memory 158, a Bluetooth (BT) and/or Universal Serial Bus (USB) subsystem 162, an audio processing device 164, an external headset port 166, an analog microphone 168, speaker(s) 170, a Bluetooth headset 172, a hearing aid compatibility (HAC) coil 174, a dual digital microphone 176, and a vibration transducer 178. The antenna 151 may be used for reception and/or transmission of RF signals. Different wireless systems may use different antennas for transmission and reception.

The transmitter 152 may comprise suitable logic, circuitry, and/or code that may be operable to modulate and up-convert baseband signals to RF signals for transmission by one or more antennas, which may be represented generically by the antenna 151. The transmitter 152 may be operable to execute other functions, for example, filtering the baseband and/or RF signals, and/or amplifying the baseband and/or RF signals. Although a single transmitter 152 is shown, the invention is not so limited. Accordingly, there may be a plurality of transmitters and/or receivers. In this regard, the plurality of transmitters may enable the wireless system 150 to handle a plurality of wireless protocols and/or standards including cellular, wireless local area networking (WLAN), and personal area networking (PAN). In addition, the transmitter 152 may be combined with the receiver 153 and implemented as a combined transmitter and receiver (transceiver).

The receiver 153 may comprise suitable logic, circuitry, and/or code that may be operable to down-convert and demodulate received RF signals to baseband signals. The RF signals may be received by one or more antennas, which may be represented generically by the antenna 151. The receiver 153 may be operable to execute other functions, for example, filtering the baseband and/or RF signals, and/or amplifying the baseband and/or RF signals. Although a single receiver 153 is shown, the invention is not so limited. Accordingly, there may be a plurality of receivers. In this regard, the plurality of receivers may enable the wireless system 150 to handle a plurality of wireless protocols and/or standards including cellular, WLAN, and PAN. In addition, the receiver 153 may be implemented as a combined transmitter and receiver (transceiver).

The DSP 154 may comprise suitable logic, circuitry, and/or code that may be operable to process audio signals. In various embodiments of the invention, the DSP 154 may encode, decode, modulate, demodulate, encrypt, and/or decrypt audio signals. In this regard, the DSP 154 may be operable to perform computationally intensive processing of audio signals.

The processor 156 may comprise suitable logic, circuitry, and/or code that may be operable to configure and/or control one or more portions of the system 150, control data transfers between portions of the system 150, and/or otherwise process data. Control and/or data information may be transferred between the processor 156 and one or more of the transmitter 152, the receiver 153, the DSP 154, the memory 158, the audio processing device 164, and the BT and/or USB subsystem 162. The processor 156 may be utilized to update and/or modify programmable parameters and/or values in one or more of the transmitter 152, the receiver 153, the DSP 154, the memory 158, the audio processing device 164, and the BT and/or USB subsystem 162. In this regard, a portion of the programmable parameters may be stored in the system memory 158. The processor 156 may be any suitable processor or controller. For example, the processor may be a reduced instruction set computing (RISC) microprocessor such as an advanced RISC machine (ARM), advanced virtual RISC (AVR), microprocessor without interlocked pipeline stages (MIPS), or programmable intelligent controller (PIC).

The system memory 158 may comprise suitable logic, circuitry, and/or code that may be operable to store a plurality of control and/or data information, including parameters needed to configure one or more of the transmitter 152, the receiver 153, the DSP 154, and/or the audio processing device 164. The system memory 158 may store at least a portion of the programmable parameters that may be manipulated by the processor 156.

In an exemplary embodiment of the invention, the DSP 154 and processor 156 may exchange audio data and control information via the memory 158. For example, the processor 156 may write encoded audio data, such as MP3 or MC audio, to the memory 158 and the memory may pass the encoded audio data to the DSP 154. Accordingly, the DSP 154 may decode the data and write pulse-code modulated (PCM) audio back into the shared memory for the processor 156 to access and/or to be delivered to the audio processing device 164.

The BT and/or USB subsystem 162 may comprise suitable circuitry, logic, and/or code that may be operable to transmit and receive Bluetooth and/or Universal Serial Bus (USB) signals. The BT and/or USB subsystem 162 may be operable to up-convert, down-convert, modulate, demodulate, and/or otherwise process BT and/or USB signals. In this regard, the BT and/or USB subsystem 162 may handle reception and/or transmission of BT and/or USB signals via a wireless communication medium and/or handle reception and/or transmission of USB signals via a wireline communication medium. Information and/or data received via a BT and/or USB connection may be communicated between the BT and/or USB subsystem 162 and one or more of the transmitter 152, the receiver 153, the DSP 154, the processor 156, the memory 158, and the audio processing device 164. For example, the BT and/or USB subsystem 162 may extract audio from a received BT and/or USB signal and may convey the audio to other portions of the wireless system 150 via an inter-IC sound (I²S) bus. Information and/or data may be communicated from one or more of the transmitter 152, the receiver 153, the DSP 154, the processor 156, the memory 158, and the audio processing device 164 to the BT and/or USB subsystem 162 for transmission over a BT and/or USB connection. For example, audio signals may be received from other portions of the wireless system 150 via an 12S bus and the audio signal may be transmitted via a BT and/or USB connection. Additionally, control and/or feedback information may be communicated between the BT and/or USB subsystem 162 and one or more of the transmitter 152, the receiver 153, the DSP 154, the processor 156, the memory 158, and the audio processing device 164.

The audio processing device 164 may comprise suitable circuitry, logic, and/or code that may be operable to process audio signals received from and/or communicated to input and/or output devices. The input devices may be within or communicatively coupled to the wireless device 150, and may comprise, for example, the analog microphone 168, the stereo speakers 170, the Bluetooth headset 172, the hearing aid compatible (HAC) coil 174, the dual digital microphone 176, and the vibration transducer 178. The audio processing device 164 may up-sample and/or down-sample audio signals to one or more desired sample rates for communication to an audio output device, the DSP 154, and/or the BT and/or USB subsystem 162. In this regard, the audio processing device 164 may also be enabled to handle a plurality of data sampling rate inputs. For example, the audio processing device 164 may accept digital audio signals at sampling rates such as 8 kHz, 11.025 kHz, 12 kHz, 16 kHz, 22.05 kHz, 24 kHz, 32 kHz, 44.1 kHz, and/or 48 kHz. The audio processing device 164 may be enabled to handle a plurality of digital audio inputs of various resolutions, such as 16 or 18-bit resolution, for example. The audio processing device 164 may support mixing of a plurality of audio sources. For example, the audio processing device 164 may support audio sources such as general audio, polyphonic ringer, I²S FM audio, vibration driving signals, and voice. In an exemplary embodiment of the invention, the general audio and polyphonic ringer sources may support the plurality of sampling rates that the audio processing device 164 may be enabled to accept, while the voice source may support a portion of the plurality of sampling rates, such as 8 kHz and 16 kHz.

The audio processing device 164 may utilize a programmable infinite impulse response (IIR) filter and/or a programmable finite impulse response (FIR) filter for at least a portion of the audio sources to compensate for passband amplitude and phase fluctuation for different input and/or output devices. In this regard, filter coefficients may be configured or programmed dynamically based on operations. For example, a frequency compensation filter may be configured based on an audio output device being utilized and/or based on power consumption constraints. Moreover, filter coefficients may all be switched in one-shot or may be switched sequentially, for example. The audio processing device 164 may also utilize a modulator, such as a Delta-Sigma (ΔΣ) modulator, for example, to code digital output signals for analog processing. The audio processing device 164 may be referred to, for example, as an audio coding and/or decoding device or CODEC. In various embodiments of the invention, the audio processing device 164 may be implemented in dedicated hardware.

The external headset port 166 may comprise a physical connection for an external headset to be communicatively coupled to the wireless system 150. The headset may, for example, be an analog headset comprising a microphone and a pair of stereo transducers. Alternatively, the headset may be a digital headset which may utilize a protocol such as USB for communicating audio information.

The analog microphone 168 may comprise suitable circuitry, logic, and/or code that may detect sound waves and convert them to electrical signals via a piezoelectric effect, for example. The electrical signals generated by the analog microphone 168 may comprise analog signals that may require analog to digital conversion before processing.

The one or more speakers 170 may be operable to generate acoustic waves from electrical signals received from the audio processing device 164. In an exemplary embodiment of the invention, there may be a pair of speakers which may be operable to output acoustic waves corresponding to, for example, left and right stereo channels.

The Bluetooth headset 172 may comprise a wireless headset that may be communicatively coupled to the wireless system 150 via the BT and/or USB subsystem 162. In this manner, the wireless system 150 may be operated in a hands-free mode, for example.

The HAC coil 174 may comprise suitable circuitry, logic, and/or code that may enable communication between the wireless device 150 and a hearing aid, for example. In this regard, audio signals may be magnetically coupled from the HAC coil 174 to a coil in a user's hearing aid.

The dual digital microphone 176 may comprise suitable circuitry, logic, and/or code that may detect sound waves and convert them to electrical signals. The electrical signals generated by the dual digital microphone 176 may comprise digital signals, and thus may not require analog to digital conversion prior to digital processing in the audio processing device 164.

The vibration transducer 178 may comprise suitable circuitry, logic, and/or code that may be operable to notify a user of events on the wireless device 150 such as calendar reminders, a low battery notification, a received signal strength notification, an incoming call, and an incoming message without the use of sound. Aspects of the invention may enable the vibration transducer 178 to generate vibrations that may be in synch with, for example, audio signals such as speech, music, ringtones, and/or continuous wave (CW) tones.

In operation, audio signals from the receiver 153, the processor 156, and/or the memory 158 may be conveyed to the DSP 154. The DSP 154 may process the signals to generate output baseband audio signals to the audio processing device 164. Additionally, baseband audio signals may be conveyed from the BT and/or USB subsystem 162, the analog microphone 168, and/or the digital microphone 176, to the audio processing device 164.

The audio processing device 164 may process and/or condition one or more of the baseband audio signals to make them suitable for conveyance to the one or more speakers 170, the headset 166, the HAC 174, the vibration transducer 178, the transmitter 152, and/or the BT and/or USB subsystem 162. In this regard, in one embodiment of the invention, the processing and/or conditioning of audio signals may comprise filtering the audio signals to compensate for a frequency response of an audio output device and/or uplink signal path to which the audio signals may be communicated. In various embodiments of the invention, a frequency compensation filter may be communicatively coupled to an active audio output device or uplink signal path at a time and the frequency compensation may be configured based on the active audio output device or uplink signal path. Configuration of the frequency response filter may enable controlling a power consumption of the frequency compensation filter.

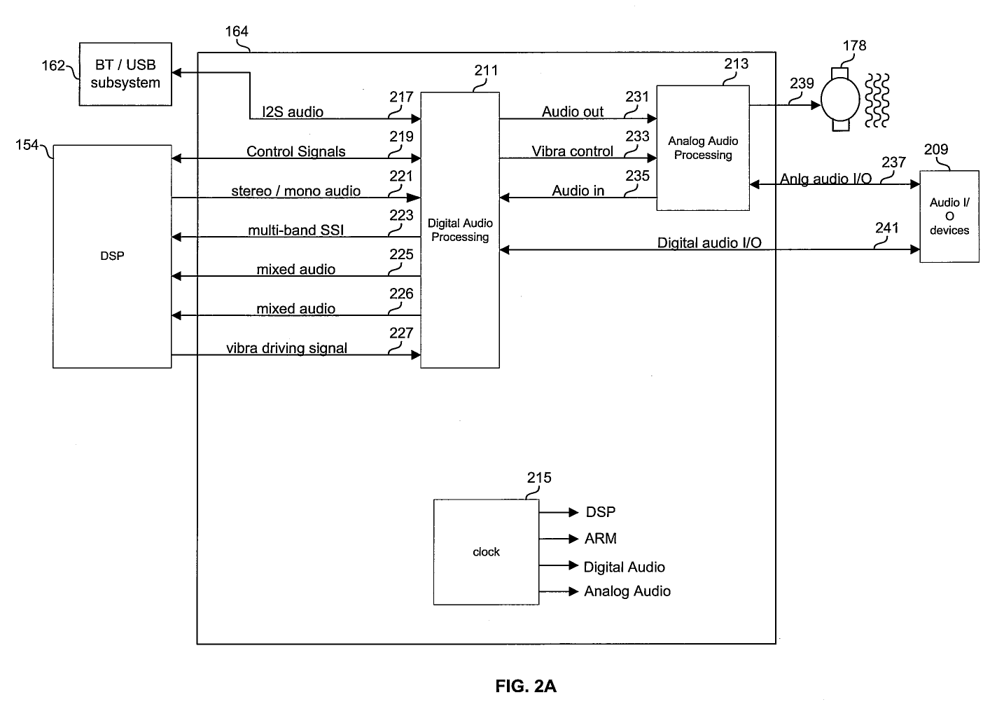

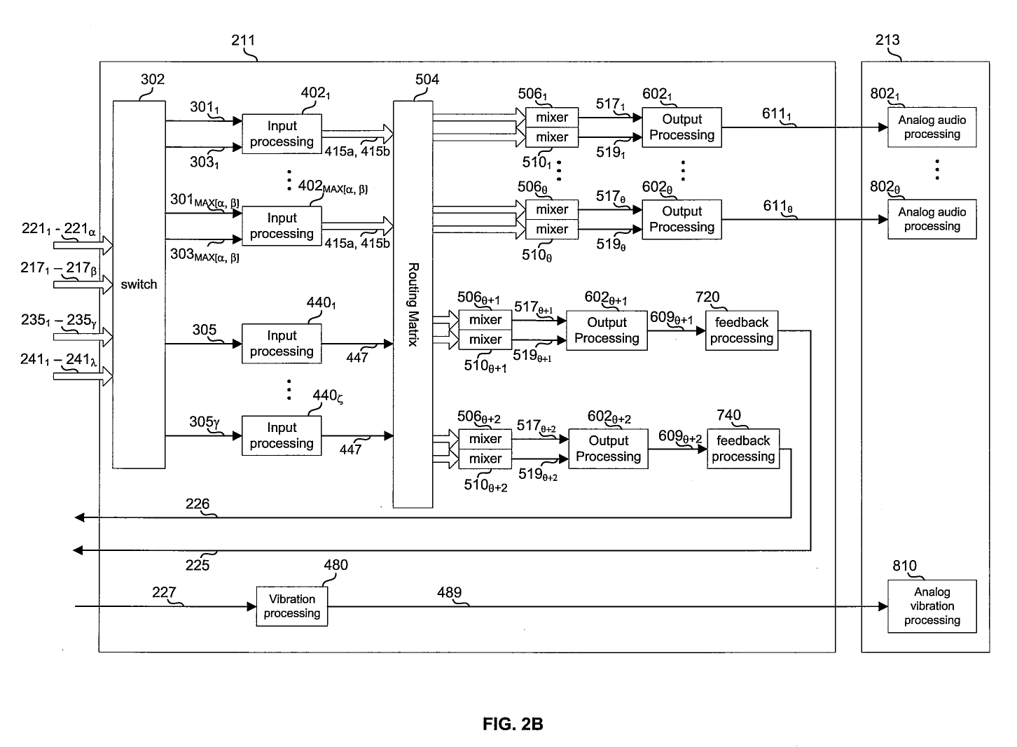

FIG. 2A is a block diagram illustrating an exemplary audio processing device, in accordance with an embodiment of the invention. Referring to FIG. 2A, there is shown the DSP 154, the BT and/or USB subsystem 162, the audio processing device 164, and audio input and/or output devices 209. The audio input and/or output devices 209 may comprise one or more devices such as the external headset port 166, the analog microphone 168, the speakers 170, the Bluetooth headset 172, the hearing aid compatibility (HAC) coil 174, the dual digital microphone 176, and the vibration transducer 178 described with respect to FIG. 1. The DSP 154 and the BT and/or USB subsystem 162 may be as described with respect to FIG. 1. The audio processing device 164 may be as described with respect to FIG. 1 and may comprise a digital portion 211, an analog portion 213, and a clock 215.

The digital portion 211 may comprise suitable logic, circuitry, and/or code that may enable processing audio signals in the digital domain. In this regard, the digital portion 211 may be operable to filter, buffer, up-sample, down-sample, apply a digital gain or attenuation to, route, and/or otherwise condition digital audio signals. Additional details of the digital portion 211 are described below with respect to FIGS. 2B, 3, 4, and 5.

The analog portion 213 may comprise suitable logic, circuitry, and/or code that may enable conversion of digital audio signals to an analog representation and amplifying and/or buffering the analog signals for driving audio output devices. Additional details of the analog portion 213 are described below with respect to FIG. 2B.

The clock 215 may comprise suitable logic, circuitry, and/or code that may be operable to generate one or more periodic signals. The clock 215 may, for example, comprise one or more crystal oscillators, phase locked loops (PLLs), and/or direct digital frequency synthesizers (DDFS). The clock 215 may output a plurality of signals each with a distinct frequency and/or phase. The signals output by the clock 215 may be conveyed to one or more of the digital portion 211, the analog portion 213, the DSP 154, the memory 158, and/or the processor 156.

In various exemplary embodiments of the invention, one or more audio signals 217 may be communicated between the digital portion 211 and the BT and/or USB subsystem 162 via an inter-IC sound (I²S) bus. Each of the audio signals 217 may be a monaural channel, a left stereo channel, or a right stereo channel. In an exemplary embodiment of the invention, the BT and/or USB subsystem 162 may be enabled to receive and/or process audio broadcasts, and thus, two signals 217 comprising left and right channel audio may be conveyed to the digital portion 211 via an I²S bus. In this regard, exemplary audio broadcasts may comprise FM stereo, “HD radio”, DAB, DAB+, and satellite radio broadcasts.

In various exemplary embodiments of the invention, one or more output audio signals 231, vibration control 233, and input audio signals 235 may be communicated between the digital portion 211 and the analog portion 213.

The output audio signals 231 may each comprise one or more digital audio signals which have been suitably processed and/or conditioned by the digital portion 211 for output via one or more of the audio output devices 209. Each of the audio signals 231 may be a monaural channel, a left stereo channel, or a right stereo channel. Each of the output audio signals 231 may be converted to an analog representation and amplified by the analog portion 213.

The input audio signals 235 and 241 from an audio input device 209 may each comprise one or more digital audio signals to be processed by the digital portion 211. The input audio signals 235 and/or 241 may comprise monaural and/or stereo audio data which the digital portion 211 may process for conveyance to the DSP 154 and subsequent transmission to a remote wireless device. The input audio signals 235 and/or 241 may comprise monaural and/or stereo audio data which the digital portion 211 may process in a “loopback” path for conveyance to one or more audio output devices 209.

The vibration control signal 233 may be a pulse width modulated square wave that may, after being amplified by the analog portion 213, control vibration of the vibration transducer 178. In various exemplary embodiments of the invention, spectral shaping techniques may be applied in the pulse width modulation function to reduce noise in the audible band.

In various exemplary embodiments of the invention, one or more control signals 219, one or more audio signals 221, one or more SSI signals 223, one or more mixed audio signals 225 and/or 226, and one or more signals 227 for driving a vibration transducer may be communicated between the DSP 154 and the digital portion 211. Monaural and/or stereo audio data may be extracted from RF signals received by the receiver 153 and processed by the DSP block 154 before being conveyed to the digital portion 211 of the processing device 164. One or more signals communicated between the DSP 154 and the digital portion 211 may be buffered. For example, voice signals may not be buffered while music and/or ringtone signals may be written to a first-in-first-out (FIFO) buffer by the DSP 154 and then fetched from the FIFO by the digital portion 211.

The one or more control signals 219 may be utilized to configure various operations of the digital portion 211 based, for example, on a resolution and/or sampling rate of signals being output by the DSP 154. In various embodiments of the invention, one or more control registers for the digital portion 211 may reside in the DSP 154. In various embodiments of the invention, the control signals 219 may comprise one or more interrupt signals.

The audio signals 221 may each comprise, for example, voice data, music data, or ringtone data. Each audio signal 221 may be monaural signal, a left stereo channel, or a right stereo channel. The digital portion 211 may condition and/or process the audio signals 221 for conveyance to one or more audio output devices and/or uplink paths. In various embodiments of the invention, the resolution and/or sample rate of the audio signals 221 may vary. Exemplary resolutions may comprise 16-bit and 18-bit resolution. Exemplary sample rates may comprise 8 kHz, 11.05 kHz, 12 kHz, 16 kHz, 22.05 kHz, 24 kHz, 32 kHz, 44.1 kHz, and 48 kHz.

The signal strength indicator (SSI) signals 223 may comprise one or more feedback signals from the digital portion 211 to the DSP 154. The SSI signals 223 may provide an indication of signal strength of one or more frequency bands of one or more audio signals 221, 225, and/or 226. The SSI signals 223 may, for example, be utilized by the DSP 154, the processor 156, the memory 158, or a combination thereof to control a digital gain factor applied to each sub-band of one or more audio signals 221, 225, and/or 226. Additionally, detected signal amplitudes may be utilized to generate an audio visualization. For example, one or more LEDs or an image displayed by the wireless system 150 may be controlled based on the detected signal amplitudes.

The signal 227 may comprise audio data utilized to control a vibration transducer 178. The signal 227 may comprise, for example, CW tone data, voice data, music data, or ringtone data. Characteristics such as intensity of vibration, a pattern in which vibration is started and stopped, a frequency at which vibration may be started and/or stopped, and/or a duration of a vibration or sequence of vibrations may be controlled based on the signal 227.

The one or more mixed audio signals 225 and the one or more mixed audio signals 226 may be output by the digital portion 211 to the DSP 154. The mixed audio signals 225 may each be a composite signal comprising information from one or more monaural signals and/or stereo audio signals. Similarly, the mixed audio signals 226 may each be a composite signal comprising information from one or more monaural signals and/or stereo audio signals. In this regard, one or more of the audio signals 221, one or more of the input audio signals 235, one or more of the input audio signals 241, and/or one or more of the audio signals 217 may be mixed together. Each of the audio signals 221, 235, 241, and 217 may be, for example, amplified, attenuated, band limited, up-converted, down-converted or otherwise processed and/or conditioned prior to mixing. The mixed audio signals 225 may be part of and/or coupled to an uplink path. For example, the signals 225 may be processed by the DSP 154 and transmitted, via the BT and/or USB subsystem 162, to a remote wireless system. Similarly, the mixed audio signal) 226 may be part of and/or coupled to an uplink path. For example, the signals 226 may be processed by the DSP 154 and transmitted, via the transmitter 152, to a far-end communication partner or a remote wireless system.

In operation, one or more baseband audio signals 217, 221, 235, and/or 241 may be conveyed to the audio processing device 164 from one or more of the DSP 154, the BT and/or USB subsystem 162, and the input and/or output devices 209. The digital portion 211 of the audio processing device 164 may select which baseband audio signals 221 to process. Each of the selected audio signals may be processed based on factors such as whether the signal is one of a pair of stereo signals or is a monaural signal; whether the signal comprises voice, music, or ringtone data; a resolution of the signal; and a sample rate of the signal. Selected audio signals may be processed in an input processing path comprising one or more input audio processing blocks 402 and/or 440 (FIG. 2B). The input audio processing path may be operable to process and/or condition audio signals based on a source and/or various characteristics of the audio signal. Subsequently, audio signals may be mapped from one or more input processing paths to one or more output processing paths. The output processing path may comprise one or more mixers 506 and/or 510 (FIG. 2B), output audio processing blocks 602 (FIG. 2B), feedback audio processing block 720 (FIG. 2B), and/or feedback processing block 740 (FIG. 2B). The output processing path may condition signals based on one or more output devices 209 and/or uplink paths to which the audio signals may be conveyed. In this regard, conditioning of audio signals by the output processing path may comprise filtering the audio signals to compensate for a frequency response of an audio output device and/or uplink signal path to which the audio signals 225, 226, 231, and/or 241 may be communicated.

FIG. 2B is a block diagram illustrating exemplary digital processing and analog processing portions of an audio processing device, in accordance with an embodiment of the invention. Referring to FIG. 2B, there is shown a digital portion 211 and an analog portion 213.

The digital portion 211 may comprise a switching element 302, a plurality of input audio processing blocks 402, a plurality of input audio processing blocks 440, a digital vibration processing block 480, a routing matrix 504, a plurality of mixers 506 and 510, a plurality of output audio processing blocks 602, a feedback audio processing block 720, and a feedback audio processing block 740.

The switching element 302 may be operable to route one or more of the signals 221₁ . . . 221_{α} (collectively referred to herein as signals 221), 217₁ . . . 217_{β} (collectively referred to herein as signals 217), 235₁ . . . 235_{γ} (collectively referred to herein as signals 235), and/or 241₁ . . . 241_{λ} (collectively referred to herein as signals 241) from the DSP 154, BT and/or USB subsystem 162, and audio input devices 209 to the digital portion 211, where α, β, γ and λ are integers greater than or equal to 1. Which signals 221, 217, 235, and/or 241 are routed to one or more input audio processing blocks 402 and/or 440 may be determined based on one or more control signals received from, for example, the DSP 154, the processor 156, and/or the BT and/or USB subsystem 162. In this regard, the switching element 302 may be configured dynamically and/or in real-time so as to provide processing whenever it may be required.

Each of the input audio processing blocks 402 may comprise suitable logic, circuitry, and/or code that may be operable to condition monaural or stereo input audio signals. Processing of an audio signal by each of the input audio processing blocks 402 may be based on a type of audio content in the signal, a source of the audio signal, and/or a sample rate of the audio signal. Each of the input audio processing blocks 402 may be operable to buffer an audio signal 301 and/or 303. One or more of the input audio processing blocks 402 may be operable to control whether audio data is processed as a left stereo channel, a right stereo channel, or a monaural signal. Each of the input audio processing blocks 402 may be operable to measure strength of one or more audio signals 301 and/or 303 and generate one or more feedback signals corresponding to the measured strength. Each of the input audio processing blocks 402 may be operable to filter the one or more audio signals 301 and/or 303, and/or up-sample and/or down-sample the audio signals 301 and/or 303. Each of the input audio processing blocks 402 may be operable to adjust signal levels of the signals 415a and 415b. In various embodiments of the invention, one or more of the input audio processing blocks 402 may be configured via one or more control signals received from, for example, the DSP 154, the processor 156, and/or the BT and/or USB subsystem 162. In this regard, the input audio processing blocks 402 may be configured dynamically and/or in real-time so as to provide processing whenever it may be required.

Each of the input audio processing blocks 440 may comprise suitable logic, circuitry, and/or code that may be operable to condition monaural input audio signals. Processing of an audio signal 305 by each of the input audio processing blocks 440 may be based on a type of audio content in the signal 305, a source of the audio signal 305, and/or a sample rate of the audio signal 305. Each of the audio processing blocks may be operable to buffer an audio signal 305, filter the audio signal 305, and/or up-sample or down-sample the audio signal 305. Each of the input audio processing blocks 440 may be operable to adjust signal levels of the signal 447. In various embodiments of the invention, one or more of the input audio processing blocks 440 may be configured via one or more control signals received from, for example, the DSP 154, the processor 156, and/or the BT and/or USB subsystem 162. In this regard, the input audio processing blocks 440 may be configured dynamically and/or in real-time so as to provide processing whenever it may be required.

The digital vibration processing block 480 may comprise suitable logic, circuitry, and/or code that may be operable to process and/or condition one or more of the baseband audio signals to generate one or more signals 489 for controlling the vibration transducer 178. In this regard, the digital vibration processing block 480 may be operable to control vibrations based on an audio signal. In an exemplary embodiment of the invention, various characteristics such as intensity of vibration, a pattern in which vibration is started and stopped, a frequency at which vibration is started and stopped, and/or duration of a vibration or sequence of vibrations may be controlled based on an audio signal input to the digital vibration processing block 480. The digital vibration processing block 480 may be configured via one or more control signals received from, for example, the DSP 154, the processor 156, and/or the BT and/or USB subsystem 162. In this regard, the digital vibration processing block 480 may be configured dynamically and/or in real-time so as to provide processing whenever it may be required.

The routing matrix 504 may comprise suitable logic, circuitry, and/or code that may be operable to route each of the signals 415 and 447 to one or more of the mixers 506 and/or 510. The routing matrix 504 may be configured via one or more control signals from, for example, the processor 156, the DSP 154, and/or the memory 158. Moreover, configuration of the routing matrix 504 may occur dynamically and/or in real-time so as to provide processing whenever it may be required. In various embodiments of the invention, the routing matrix 504 may comprise one or more multiplexers or similar switching elements. Routing of each input signal 415 and/or 447 may depend, at least in part, on an output device 209 and/or uplink path for which each signal 415 and 447 may be destined. In this regard, the routing and re-routing of signals between inputs and outputs of the audio processing device 164 may occur in real-time.

Routing of each input signal 415 and/or 447 may be independent of the routing of other input signals 415 and 447, independent of the source of each signal 415 and/or 447, and independent of whether each signal 415 and/or 447 is a stereo channel or a monaural channel. Thus, upstream from the routing matrix 504 audio signals may be processed according to an input of the processing device 164 on which the audio signals where received and downstream from the routing matrix 504 audio signals may be processed based on an output of the processing device 164 for which the signals are destined. In this manner, the processing device 164 may provide flexibility in routing audio signals of various types from various sources to one or more audio output devices and/or uplink paths. Upstream from the routing matrix 504 may comprise the input audio processing blocks 402 and 440. Downstream from the routing matrix 504 may comprise the mixers 506 and 510, the output audio processing blocks 602, the feedback audio processing block 720, and the feedback audio processing block 740.

The mixers 506 and 510 may each comprise suitable logic, circuitry, and/or code that may be operable to combine audio signals into a composite audio signal. Each mixer 506 may combine up to η audio signals to generate a composite audio signal 517. Similarly each mixer 510 may combine up to η audio signals to generate a composite audio signal 519. In various embodiments of the invention, each signal 517₁ . . . 517_{θ+2}, may be a left stereo channel and each signal 519₁ . . . 519_{θ+2}, may be a right stereo channel. In an exemplary embodiment of the invention, the mixers 506 and 510 may output up to θ+2 stereo signals or up to 2(θ+2) monaural signals to a number, θ, of analog audio processing blocks 802, the feedback audio processing block 720, and the feedback audio processing block 740 via the output audio processing blocks 602. The mixers 506 and 510 may be configured via one or more control signals from, for example, the processor 156, the DSP 154, and/or the memory 158. In this regard, the mixers 506 and/or 510 may be configured dynamically and/or in real-time so as to provide processing whenever it may be required.

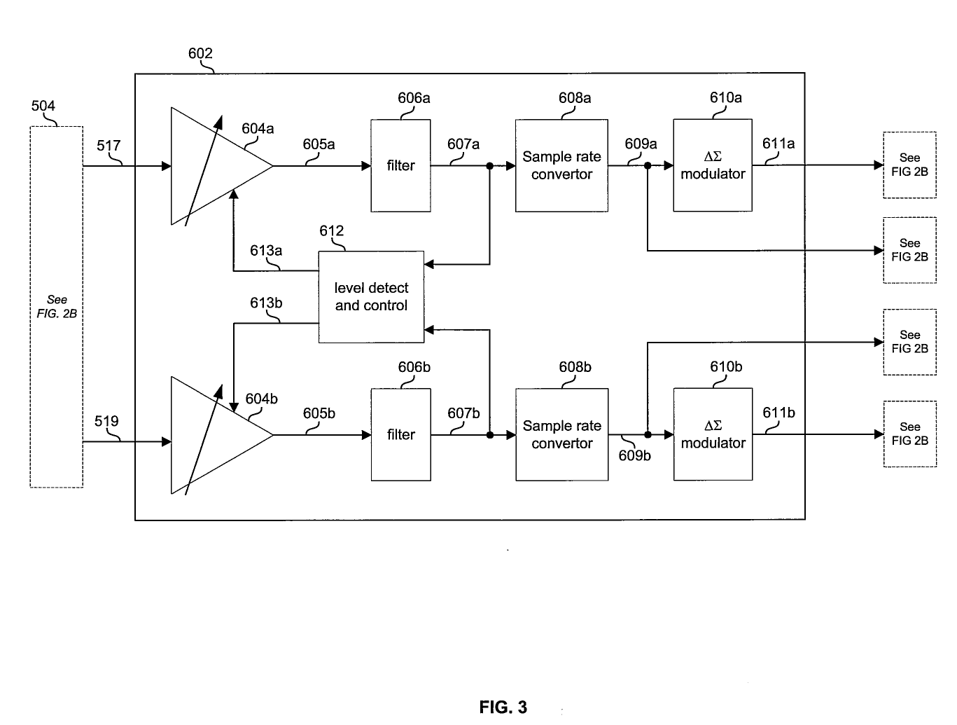

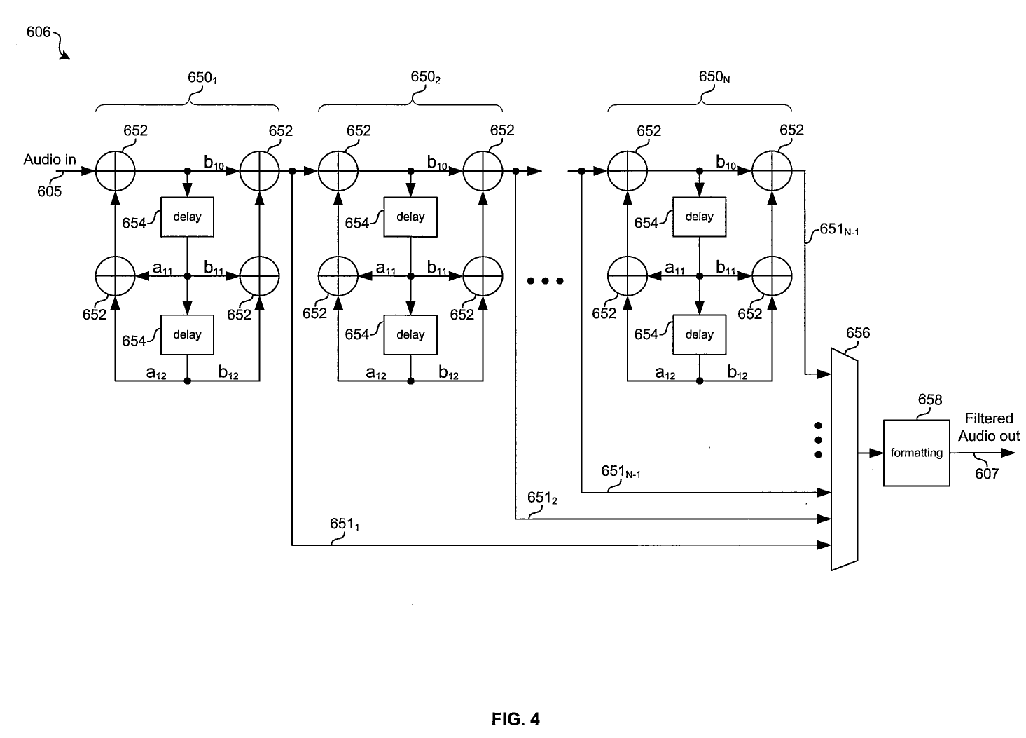

Each output audio processing blocks 602 may comprise suitable logic, circuitry, and/or code that may be operable to process audio signals for conveyance to one or more analog audio processing blocks 802, the feedback audio processing block 720, and the feedback audio processing block 740. Details of an exemplary output audio processing block 602 are described with respect to FIGS. 3 and 4.

The feedback audio processing block 720 may comprise suitable logic, circuitry, and/or code that may be operable to process and/or condition one or more of the baseband audio signals to generate one or more signals 225. In various embodiments of the invention, one or more signals 225 may be conveyed to an uplink signal path via the DSP 154 and/or the BT and/or USB subsystem 162. In this regard, the audio signal(s) 225 may comprise voice, music, and/or ringtone data which may be communicated to a remote wireless device utilizing BT and/or USB protocols. In various embodiments of the invention, one or more signals 225 may be conveyed to an output device such as the BT headset 172 via the BT and/or USB subsystem 162. The feedback audio processing block 720 may be operable to up-sample and/or down-sample audio signals, adjust signal levels of the output signal 225, and/or buffer audio signals. The feedback audio processing block 720 may be configured via one or more control signals received from, for example, the DSP 154, the processor 156, and/or the BT and/or USB subsystem 162. In this regard, the feedback audio processing block 720 may be configured dynamically and/or in real-time so as to provide processing whenever it may be required.

The feedback audio processing block 740 may comprise suitable logic, circuitry, and/or code that may be operable to process and/or condition one or more baseband audio signals to generate one or more signals 226 which may be conveyed to an uplink signal path via the DSP 154 and/or transmitter 152. In this regard, the audio signal 226 may comprise voice, music, and/or ringtone data which may be communicated to a remote wireless device utilizing, for example, cellular, WLAN, and/or PAN protocols. The feedback audio processing block 740 may be operable to up-sample and/or down-sample audio signals. The feedback audio processing block 740 may be configured via one or more control signals received from, for example, the DSP 154, the processor 156, and/or the BT and/or USB subsystem 162. In this regard, the feedback audio processing block 740 may be configured dynamically and/or in real-time so as to provide processing whenever it may be required.

Each of the analog audio processing blocks 802 may comprise suitable logic, circuitry, and/or code that may be operable to condition audio signals for driving an audio output device 209. Each analog audio processing block 802 may be operable to convert a digital audio signal to an analog representation. Each analog audio processing block 802 may be operable to buffer and/or amplify analog audio signals for driving an audio output device 209. The analog audio processing blocks 802 may be configured via one or more control signals which may be received from, for example, the DSP 154, the processor 156, and/or the BT and/or USB subsystem 162. In this regard, the analog audio processing blocks 802 may be configured dynamically and/or in real-time so as to provide processing whenever it may be required.

The analog vibration processing block 810 may comprise suitable logic, circuitry, and/or code that may be operable to buffer and/or amplify the signal 489 for driving the vibration transducer 178. In this regard, driving the vibration transducer 178 may require more current than the digital vibration processing block 480 may be able to output and thus the analog vibration processing block 810 may provide increased output current for driving the vibration transducer 178. The analog vibration processing block 810 may be configured via one or more control signals received from, for example, the DSP 154, the processor 156, and/or the BT and/or USB subsystem 162. In this regard, the analog vibration processing block 810 may be configured dynamically and/or in real-time so as to provide processing whenever it may be required.

In operation, the switching element 302 may select one or more audio signals to be routed to one or more of the input audio processing blocks 402 and/or the input audio processing blocks 440. Each of the input audio processing blocks 402 and/or 440 may condition audio signals and convey them to the routing matrix 504. The routing matrix 504 may route the audio signals to one or more mixers 506 and/or 510. Each of the mixers 506 and/or 510 may be operable to mix together one or more audio signals into a composite audio signal 517 and/or 519. The signals 517 and/or 519 may each be conveyed to an output audio processing block 602. Each of the output audio processing blocks 602 may condition audio signals for conveyance to an analog audio processing block 802, the feedback audio processing block 720, or the feedback audio processing block 740. In this regard, each of the output audio processing blocks 602 may comprise a frequency compensation filter operable to filter an audio signal based on an audio output device 209 or uplink signal path to which the audio signal may be conveyed. The signals 611₁, . . . , 611_{θ} may each be conveyed to an analog processing block 802 which may convert the signals 611₁, . . . , 611_{θ} to an analog representation and buffer and/or amplify the analog audio signal to drive an audio output device 209. The signal 609_{θ+1} may be conveyed to the feedback audio processing block 720 which may process and/or condition the signal 609_{θ+1} and convey the signal to an uplink signal path for transmission to a remote wireless device. The signal 609_{θ+2} may be conveyed to the feedback audio processing block 740 which may condition the signal 609_{θ+2} and convey the signal to an uplink signal path for transmission to a remote wireless device. Signal levels of the signals 609 and/or 611 output by each of the output audio processing blocks 602 may be controlled to prevent over-driving an audio output device 209 or an uplink path. Additional details of the output audio processing block 602 are described below with respect to FIGS. 3 and 4.

FIG. 3 is a block diagram illustrating processing audio signals via a hardware audio CODEC for conveyance to an audio output device and/or an uplink path, in accordance with an embodiment of the invention. Referring to FIG. 3, the output audio processing block 602 may comprise digital gain blocks 604a and 604b, frequency compensation filters 606a and 606b, sample rate converters 608a and 608b, ΔΣ modulators 610a and 610b, and level control block 612. In an exemplary embodiment of the invention, the digital portion 211 may comprise a number of output audio processing blocks 602 equal to the number of the signals 517 and 519. In this regard, the number of output audio processing blocks 602 may be equal to θ+2.

The digital gain blocks 604a and 604b may each comprise suitable logic, circuitry, and/or code that may be operable to adjust an amplitude of digital audio signals 517 and 519. In this regard, the signals 605a and 605b may be scaled versions of the signals 517 and 519, respectively. The digital gain blocks 604a and 604b may be configured, dynamically and/or in real-time, via one or more control signals from, for example, the processor 156, the DSP 154, the memory 158, and/or the level detect and control block 612. In this regard, an attenuation factor 613a of the digital gain block 604a may be controlled based on a signal strength measurement of the signal 607a by the level control block 612. Similarly, an attenuation factor 613b of the digital gain block 604b may be configured based on a signal strength measurement of the signal 607b by the level control block 612.

The frequency compensation filters 606a and 606b may comprise suitable logic, circuitry, and/or code that may be operable to compensate for the frequency response of an output device 209 to which the mixed signals 605a and 605b may be destined. The frequency compensation filters 606a and 606b may each comprise, for example, a finite impulse response (FIR) filter and/or an infinite impulse response filter (IIR). The frequency compensation filters 606a and 606b may be configured via one or more control signals from, for example, the processor 156, the DSP 154, and/or the memory 158. In this regard, filters 606a and 606b may be configured dynamically and/or real-time. For example, one or more stages of each of the frequency compensation filters 606a and 606b may be enabled or disabled based on a desired frequency response and power consumption of each of the frequency compensation filters 606a and 606b.

The sample rate converters 608a and 608b may each comprise suitable logic, circuitry, and/or code that may be operable to up-sample the signal 607a and 607b, respectively. In an exemplary embodiment of the invention, sample rate converters 608a and 608b may be operable to up-sample audio signals to about 6.5 MHz.

The ΔΣ modulators 610a and 610b may comprise suitable logic, circuitry, and/or code that may be operable to oversample the signals 609a and 609b, respectively, in order to improve noise characteristics of audio signals conveyed to the analog audio processing block 802. The ΔΣ modulators 610a and 610b may be configured via one or more control signals from, for example, the processor 156, the DSP 154, and/or the memory 158. In this regard, ΔΣ modulators 610a and 610b may be configured dynamically and/or real-time.

The level control block 612 may comprise suitable logic, circuitry, and/or code that may be operable to adjust a gain of the gain blocks 604a and/or 604b based on signal strength of the signals 607a and/or 607b. The level control block 612 may be configured via one or more control signals from, for example, the processor 156, the DSP 154, and/or the memory 158. In this regard, the level control block 612 may be configured dynamically and/or real-time so as to provide processing whenever it may be required. The level control block 612 may provide an attenuation factor 613a to the digital gain block 604a and an attenuation factor 613b to the digital gain block 604b. The level control block 612 may operate in combination with the signals 223 described with respect to FIG. 2A for maintaining output signals level to protect against overdriving an output device and/or uplink path. In this regard, the signals 223 may provide a slower, sub-band level control while the signals 613a and 613b may provide a rapid, full-band level control.

The output audio processing block 602 may process and/or condition audio signals based on an output of the processing device 164 to which the signals may be conveyed. In this regard, one or more of the digital gain blocks 604a and 604b, the frequency compensation filters 606a and 606b, the sample rate converters 608a and 608b, the ΔΣ modulators 610a and 610b, and the level control block 612 may be configured based on whether the signals 609a and 609b and/or 611a and 611b may be communicatively coupled to the feedback audio processing block 720, the feedback audio processing block 740, or to an output device 209 via an analog output processing block 802. The output audio processing block 602 may be configured via one or more control signals received from, for example, the DSP 154, the processor 156, and/or the BT and/or USB subsystem 162. In this regard, the output audio processing block 602 may be configured dynamically and/or real-time so as to provide processing whenever it may be required.

In operation, audio signals 517 and 519 may be communicatively coupled to digital gain blocks 604a and 604b, respectively. The digital gain blocks 604a and 604b may adjust levels of the signals 605a and 605b based, at least in part, on signal strength measurements performed by the level detect and control block 612. The frequency compensation filters 606a and 606b may filter the signals 605a and 605b to generate signals 607a and 607b, respectively. In this regard, a frequency response of the filters 606a and 606b may be configured based on an output device or uplink signal path to which the signals 517 and 519, respectively, may be destined. The filtered signals 607a and 607b may subsequently be up sampled and, in some instances, delta sigma modulated to generate the audio signals 611a and 611b.

FIG. 4 is a block diagram illustrating an exemplary configurable frequency compensation filter via a hardware audio CODEC, in accordance with an embodiment of the invention. Referring to FIG. 4, the frequency compensation filter 606 may comprise a plurality of biquads 650₁, . . . , 650_{N}, a switching element 656, and a formatting block 658. Each biquad 650 may comprise four adders 652, and two delay elements 654.

Each adder 652 may comprise suitable logic, circuitry, and/or code that may be operable to add two signals to generate a third signal. Each adder input may be weighted by a coefficient and the coefficients may be configurable by a system designer or via one or more control signals from the DSP 154, the processor 156, and/or the memory 158. In this regard, the coefficients b₁₀, a₁₁, b₁₁, a₁₂, and b₁₂ may be pre-configured or may be configured dynamically and/or in real-time.

Each delay element 654 may comprise suitable logic, circuitry, and/or code that may be operable to delay an audio signal by a sample period. In this regard, each delay element 654 may, for example, comprise a register clocked at the sample rate of the input signal 605.

The switching element 656 may comprise suitable logic, circuitry, and/or code that may be operable to select which of the biquad outputs 651₁, . . . , 651_{N} may be communicatively coupled to the formatting block 658. In this regard, in order to reduce power consumption, a minimum number, ‘i’, of biquads 650 necessary to achieve a desired frequency compensation may be powered up and the output 651ᵢ of biquad 650ᵢ may be selected by the switching element 656, where ‘i’ is an integer between 1 and ‘N’.

The formatting block 658 may comprise suitable logic, circuitry, and/or code that may be operable to format sample values of the audio signal 607 output by the frequency compensation filter 606. In this regard, the formatting block 658 may be operable to truncate and/or round audio signal sample values.

In operation, the filter 606 may be communicatively coupled to one or more output devices 209. The coefficients b₁₀, a₁₁, b₁₁, a₁₂, and b₁₂ may be configured or loaded based on which of the one or more output devices 209 is active. In this regard, the coefficients may be configured dynamically and/or in real-time as audio output devices become active and/or inactive. Additionally, based on a desired power consumption and/or frequency response of the filter 606 one or more of the biquads 650ᵢ, . . . 650_{N} may be disabled. Accordingly, the output 651ᵢ of the last enabled biquad 650ᵢ may be selected by the switching element 656 for conveyance to the formatting block 658. Values of the selected output 651ᵢ may then be rounded by the formatting block 658.

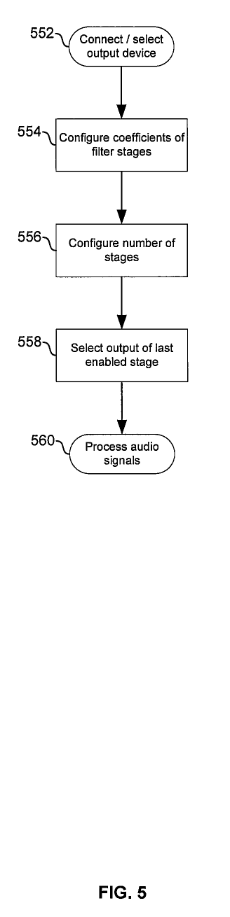

FIG. 5 is a flowchart illustrating exemplary steps for frequency compensation in a hardware audio CODEC, in accordance with an embodiment of the invention. Referring to FIG. 5 the exemplary steps may begin with step 552 when an output device may be connected or become active. For example, a user may connect a headset to the external headset port 166. Subsequent to step 552, the exemplary steps may advance to step 554. In step 554, coefficients of the filter may be loaded and/or configured. For example, coefficients corresponding to the external headset may be retrieved from the memory 158 and loaded into the filter 606 by the processor 156. Subsequent to step 554, the exemplary steps may advance to step 556. In step 556, a number of filter stages required to achieve a necessary frequency response may be enabled while remaining stages of the filter may be disabled. In this manner, a trade off between power consumption and frequency compensation may be managed to optimize performance of the wireless device 150. Subsequent to step 556, the exemplary steps may advance to step 558. In step 558, the output from the last enabled stage of the filter 606 may be selected by the switching element 658. Subsequent to step 558, the exemplary steps may advance to step 560. In step 560, the configured frequency compensation filter 606 may begin processing audio signals for conveyance to the audio output device connected and/or activated in step 552.

Various embodiments of the invention may provide a method and system for frequency compensation in an audio CODEC. In this regard, a filter 606 in a hardware audio CODEC may be configured based on power consumption and based on a frequency response of an active output device 209 to which the filter is communicatively coupled. The filter may comprise a plurality of filter stages 650, which may be, for example, biquads, and the filter 606 may be configured by enabling or disabling one or more of the stages. In this manner, power consumption of the filter 606 may be managed by enabling and/or disabling one or more stages 650. Configuration of the filter 606 may be performed dynamically depending on whether one or more audio output devices 209 may be active. In this regard, which output device 209 is active and its frequency response may be determined and filter 606 coefficients may be reconfigured upon a change in which output device 209 is active.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for frequency compensation in an audio CODEC.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. One embodiment may utilize a commercially available processor, which may be implemented external to an ASIC implementation of the present system. Alternatively, in an embodiment where the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for signal processing the method comprising:
in a hardware audio CODEC comprising a filter communicatively coupled to one or more audio output devices:
configuring said filter based on a power consumption of said filter and based on a frequency response of an active one of said one or more audio output devices; and
filtering an audio signal via said configured filter.

2. The method according to claim 1, wherein said filter comprises a plurality of filter stages.

3. The method according to claim 2, wherein each of said filter stages comprises a biquad.

4. The method according to claim 2, comprising configuring said filter by enabling or disabling one or more of said plurality of filter stages.

5. The method according to claim 4, comprising managing power consumption of said filter via said enabling or disabling of said one or more of said plurality of filter stages.

6. The method according to claim 4, comprising dynamically configuring which of said filter stages are enabled and which of said filter stages are disabled depending on whether said one or more audio output devices is active.

7. The method according to claim 1, comprising dynamically configuring coefficients of said filter upon a change in which of said one or more audio output devices is active.

8. The method according to claim 1, comprising determining whether said one or more audio output devices is active.

9. A machine-readable storage having stored thereon, a computer program having at least one code section for signal processing, the at least one code section being executable by a machine for causing the machine to perform steps comprising:
in a hardware audio CODEC comprising a filter communicatively coupled to one or more audio output devices:
configuring said filter based on a power consumption of said filter and based on a frequency response of an active one of said one or more audio output devices; and
filtering an audio signal via said configured filter.

10. The machine-readable storage according to claim 9, wherein said filter comprises a plurality of filter stages.

11. The machine-readable storage according to claim 10, wherein each of said filter stages comprises a biquad.

12. The machine-readable storage according to claim 10, wherein said at least one code section comprises code for configuring said filter by enabling or disabling one or more of said plurality of filter stages.

13. The machine-readable storage according to claim 12, wherein said at least one code section comprises code for managing power consumption of said filter via said enabling or disabling of said one or more of said plurality of filter stages.

14. The machine-readable storage according to claim 12, wherein said at least one code section comprises code for dynamically configuring which of said filter stages are enabled and which of said filter stages are disabled depending on whether said one or more audio output devices is active.

15. The machine-readable storage according to claim 9, wherein said at least one code section comprises code for dynamically configuring coefficients of said filter upon a change in which of said one or more audio output devices is active.

16. The machine-readable storage according to claim 9, wherein said at least one code section comprises code for determining whether said one or more audio output devices is active.

17. A system for signal processing, the system comprising:
one or more circuits for use in a hardware audio CODEC, said one or more circuits comprising a filter communicatively coupled to one or more audio output devices, wherein said one or more circuits are operable to:
configure said filter based on a power consumption of said filter and based on a frequency response of an active one of said one or more audio output devices; and
filter an audio signal via said configured filter.

18. The system according to claim 17, wherein said filter comprises a plurality of filter stages.

19. The system according to claim 18, wherein each of said filter stages comprises a biquad.

20. The system according to claim 18, wherein said one or more circuits are operable to configure said filter by enabling or disabling one or more of said plurality of filter stages.

21. The system according to claim 20, wherein said one or more circuits are operable to manage power consumption of said filter via said enabling or disabling of said one or more of said plurality of filter stages.

22. The system according to claim 20, wherein said one or more circuits are operable to dynamically configure which of said filter stages are enabled and which of said filter stages are disabled depending on whether said one or more audio output devices is active.

23. The system according to claim 17, wherein said one or more circuits are operable to dynamically configure coefficients of said filter upon a change in which of said one or more audio output devices is active.

24. The system according to claim 17, wherein said one or more circuits are operable to determine whether said one or more audio output devices is active.
